(19) United States
(12) Patent Application Publication
(10) Pub. No.: US 2002/0100022 A1
(43) Pub. Date: Jul. 25, 2002

(54) Method and apparatus for automatic verification of properties of a concurrent software system

(76) Inventor: Gerard J. Holzmann, Watchung, NJ (US)

Correspondence Address: HITT GAINES & BOISBRUN P.C., P.O. BOX 832570, RICHARDSON, TX, 75083, US

(21) Appl. No.: 09/850,382

(22) Filed: May 7, 2001

Related U.S. Application Data
(63) Continuation-in-part of application No. 09/809,499, filed on Mar. 15, 2001.
(60) Provisional application No. 60/202,664, filed on May 8, 2000.

(51) Int. Cl. G06F 9/44; G06F 9/45

(52) U.S. Cl. 717/126; 717/106; 717/139

(57) ABSTRACT

A verification system for verifying that a software system satisfies a property by extracting a verification model from implementation level source code is provided. The extraction proceeds by translating source strings generated from the source code into strings belonging to a target language, and generating a verification model in the target language. The translation is guided by explicit mappings in a lookup table, optional user-defined data restrictions, and default type rules. Standard logic model checking is performed on the extracted verification model to check that the system satisfies (or can possibly violate) any given explicit or implicit logic system property.

### CROSS-REFERENCE TO RELATED APPLICATIONS

This application is related to, and claims priority from, U.S. Provisional Application No. 60/202,664, entitled A Model Checker For Distributed Applications Written in C filed on May 8, 2000, and is a continuation-in-part of U.S. application Ser. No. 09/809,499 entitled Method and Apparatus for Automatically Extracting Verification Models filed on Mar. 15, 2001 which are incorporated herein by reference.

### BACKGROUND

The function of a computer system is determined by the software that it executes. The software determines both the usefulness and the vulnerability of the system. Software programs can have defects that can cause loss of functionality with generally unforeseeable consequences. Much effort in the computer industry is therefore devoted to the development of reliable test methods for computer software, that can reveal the presence of defects before a software product is deployed for real-world applications. Where at one time most software applications were designed to execute purely sequentially without significant interactions with other software applications, today most software applications of interest are of a different nature. Today's software applications typically define collections of concurrently executing processes (asynchronous flows of control) that exhibit significant interaction, both internally (within the collection of processes defined) and externally (with externally defined systems of processes). A word processing application, for instance, can interact with a spelling checker, a thesaurus application, a web browser, a remote file system, etc. The very essence of modern computer systems is the way in which they (and thereby the software applications that they run) are interconnected: locally on LANs (local area networks) and globally through the world-wide internet.

There is, however, a fundamental difficulty in testing the software for concurrent systems of processes. A sequential process normally exhibits deterministic behavior, which means that there is a pre-determined relation between the inputs provided and the outputs generated for these inputs. This makes it relatively easy to setup a test and to evaluate its result. This is quite different for a system of concurrent processes. The relative speeds of execution of concurrently executing processes is almost always uncontrollable by and unobservable to the system tester, yet it can determine all aspects of the behavior of the system, including the outputs that are generated for given inputs. In a telephone system, for instance, the behavior of the response of a switch (a hardware device controlled by many concurrently executing software processes) to any given subscriber action can depend on subtle timings of interactions with both locally and remotely executing processes. These interactions are unavoidable, and essential to providing the required functionality of the switch, but they make comprehensive system testing an extremely difficult task.

Logic model checking techniques are increasingly employed to address the testing problem for concurrent software applications. (See for instance, Gerard J. Holzmann, ‘The model checker Spin’, IEEE Trans. On Software Engineering, Vol. 23, No. 5, May 1997, pp. 279-295.) Traditionally, when these techniques are used, an expert in model checking techniques manually constructs a verification model of the application under study, guided by the designers and programmers of the application for the details of its working. The model can then be checked mechanically to establish its correctness properties, using a model checker. The manual construction of a verification model, however, has several known drawbacks. It can be time-consuming (taking weeks or months to complete); and it requires considerable expertise (typically requiring a PhD. in logic or computer science, with specialization on logic model checking techniques); and it still remains subject to human error, leaving the results of a system test in doubt.

Several attempts have been made to build translators that convert program text literally into the input language of a model checker, without the benefit of abstraction techniques. Because no abstractions are used, restrictions are imposed on the input language. Input language subsets have been defined for languages such as Ada, Java and SDL. It has also been disclosed that program slicing techniques can be used to provide a level of abstraction in extracting Finite-state models from Java Source Code. These techniques, however, have not overcome the problems with translating programming language text literally into the language of a model checker.

### SUMMARY OF INVENTION

In the method according to the principles of the invention, verification models can be extracted automatically from a given body of program source code, guided by automated and user-defined rules. The extraction process takes no substantial time (in the order of seconds for large programs). The generated model can be checked with thoroughness with standard logic model checking techniques. By automating the construction of the verification model, it becomes possible to track a body of evolving source code for a concurrent systems application with a thorough test system based on model checking, if necessary performing frequent (such as daily or even hourly) verifications.

To generate the verification model, source code parsing techniques are used to build a control flow graph for procedural elements of the source code program, and it contains information about the type and scope of the data objects used in the program. The control flow graph is expressed in alternate specification languages (target languages), including the one that is used by the logic model checking tool SPIN. The output of the parser could be represented as an uninterpreted model, interpreting only control flow structure of the program, but treating everything else as an annotation. All basic actions and branch conditions are collected, and can be tabulated, but can remain uninterpreted.

To perform the translation from source to target for the purpose of creating a verification model, the model extraction system traverses a standard parse tree of the program source code, and identifies those nodes in the parse tree that correspond to basic statements and conditional expressions (boolean conditionals). Translations are performed by selecting mappings in the following priority order: first a lookup table is searched for a matching mapping; if no matching is found in the first step, a set of user-defined data restrictions are searched for a matching data restriction; and if no matching data restriction is found, a default type rule is used. The table consists of a list of source code strings, represented in a canonical form (omitting redundant white-space characters, and inserting parentheses to establish unambiguous parsing precedences within expressions), matched with desired translations. Examples of translations can be ‘skip’ to represent a null statement in the target language, ‘true’ as a translation for an arbitrary expression, and ‘hide’ as a translation for statements that can be omitted from the generated model. As will be appreciated, the translations detailed above are illustrative in nature and can be changed as a function of user preferences or other programming considerations.

The verification model can be optimized by identifying portions of source text of an application that have no direct relevance to the verification of general functional properties of the code. With the corresponding actions hidden, the control structure can be simplified. For example, specifying a nondeterministic choice between two commented out portions of code can simplify the model without changing its semantics.

Advantageously, extracting verification models from software, e.g., source code, in accordance with the aspects of the invention, as detailed herein, provides for increased thoroughness in the verification/testing of software. Significantly, the extraction of the verification model is independent of the underlying source programming language and its associated programming constructs, and extraction according to the principles of the invention can be used in the verification of a variety of programs written in a variety of programming languages.

### BRIEF DESCRIPTION OF THE DRAWINGS

An understanding of the invention can be had with reference to the drawings, in which:

FIG. 1 is a process flow diagram for an exemplary method of model extraction according to the principles of the invention; and

FIG. 2 is an exemplary block diagram of a verification system according to the principles of the invention.

### DETAILED DESCRIPTION

The verification system according to the principles of the invention extracts a verification model from, illustratively, implementation level source code. The verification model (also called model) is defined in such a way that it is necessarily finite state. The set of all possible executions for a finite state model defines a finite, directed and possibly cyclic graph. A set of requirements that the system has to satisfy can be defined independently, in a range of ways, e.g., as formulae expressed in temporal logic, as test automata, or with the help of visual property editing tools. Logical model checking can be implemented on the extracted verification model to verify that the system satisfies the stated properties.

(A) Verification Model Extraction

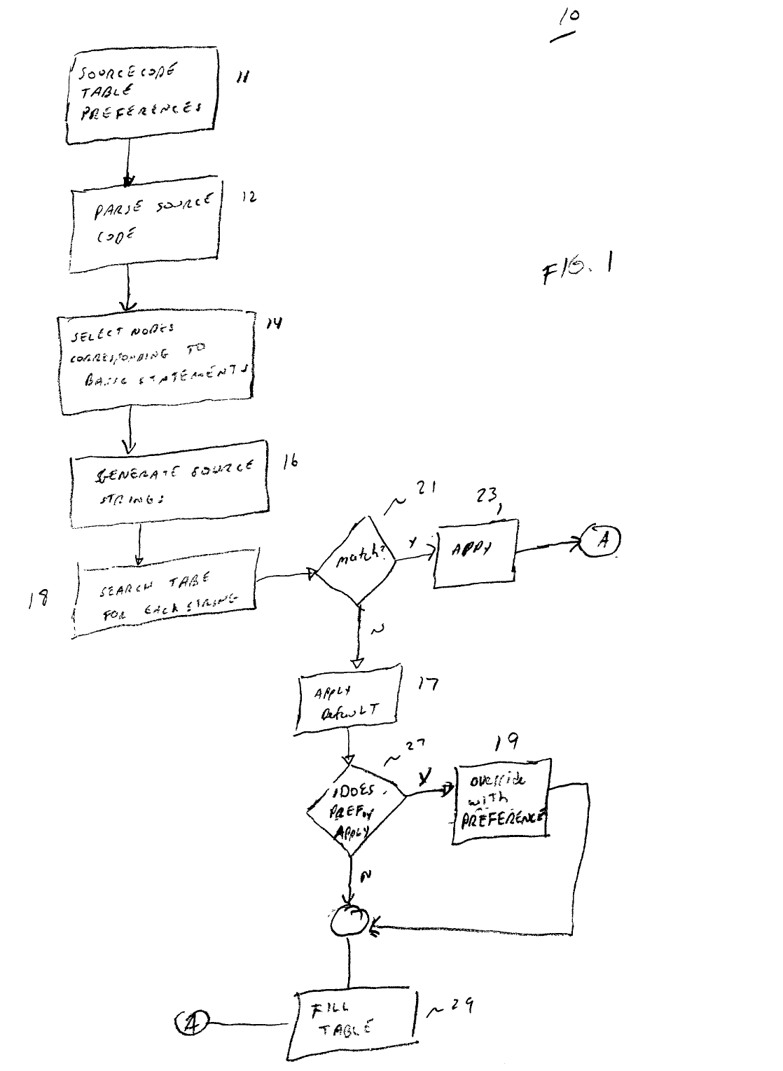

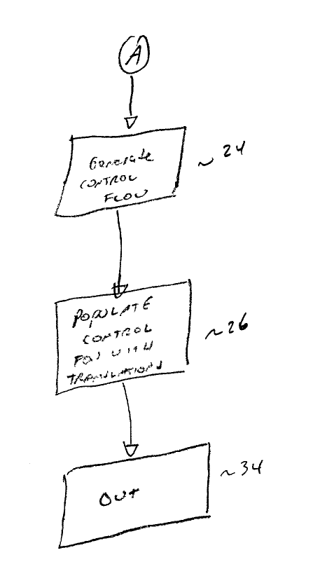

FIG. 1 illustrates a process flow diagram 10 for model extraction according to the principles of the invention. The inputs 11 to the process flow can include three parts. A first, required, input is the source text of the program that is the subject of the model extraction. A second input is a conversion or translation table. A third, optional, input can be a set of user-defined data restrictions, represented, for example, in a text-based file called the user preferences file. The process implements a three phase model extraction method. In the first phase, the parsing phase, a parse tree is built of the program text that preserves pertinent information about the original source. The second phase is an interpretation phase that maps the basic actions and conditions to an interpretation in the target language. As will be explained in more detail below, source code translations are checked against the table for possible presence of explicit translation rules into the target modeling language. In the third phase, the optimization phase, the control structure is simplified by hiding actions having no direct relevance to the verification of the general functional properties of the code. The relevance of the operations to the properties to be verified (determined by independent means) can, for instance, determine which operations need to be represented literally (i.e., with an equivalent representation in the language of the model checker), which operations can be partially abstracted, and which operations can be omitted. The resulting translations are used to populate the control flow skeleton, or control flow, for the target model, providing a verification model for the properties of interest.

(1) Parsing

Verification model extraction according to the principles of the invention accepts the source code as an input 11 and, in a first process step 12, a parse tree is constructed from the source code. The source code contains sufficient information to reproduce a valid source program from the parse tree. Construction of a parse tree from source code can be implemented with the known compiler front-end routine cTREE (also known as cTOOL), written by Shaun Filisakowski and distributed under copyright without limitations on non-commercial use. The parsing routine cTREE is also available for download from the World Wide Web. It should be apparent that the precise type of parser used to construct the parse tree is not important, and other standard methods for constructing the parse tree and control-flow graph can be used without departing from the principles of the invention. The full parse tree that is built defines the control flow structure for the procedures in the input program, and it contains information about the data objects used in the program. The output can be represented as an uninterpreted model, interpreting only control flow structure of the program and treating the other information as annotations. All basic actions, such as declarations, assignments and function calls, and branch conditions are collected, and can be tabulated, but remain uninterpreted.

(2) Interpretation

Once the parse tree (equivalently the control-flow graph) is constructed, the parse tree is traversed, and nodes that correspond to the basic statements of the source language are selected, as indicated at step 14. Illustratively, basic statements of the source language include declarations, assignments, function calls, return statements, boolean conditions and the like. From the selected nodes, canonical text strings that can later serve as the “inputs” to the lookup table or conversion table are generated. Additionally, the selected nodes form the leaves of the control flow skeleton that can be reproduced in the target language for the verification model.

For each selected node in the parse tree, a source text string is generated from the information that is available at that node in the parse tree, as at step 16. The selected nodes, as previously stated, correspond to a basic statement in the source code. The statement will generally include references to data objects for which existing values may be used or new values may be defined (e.g., in variable assignments). The selected node and related information contains the information necessary to generate the source text string (as cTREE provides a tree from which a valid source program can be generated). The precise method of source string preparation may vary without departing from the principles of the invention, and the precise source code language is not critical to the process.

In a process step 18, each source text string is searched in the table. In an exemplary embodiment, the left side entries in the lookup table are representations of the basic statements, a condition, or the condition's negation (also referred to as entries in the table) from the source text string. The right hand side specifies the interpretation of the statement in the verification model. Illustrative pre-defined interpretations are set forth in Table 1 below:

TABLE 1
Pre-defined Interpretations

| Type | Meaning |
|---|---|
| print | Embed source statement into a print action in |
| | the model |
| comment | Include in the model as comment only |
| hide | Do not represent in the model |
| keep | Preserve in the model, subject to global |
| | substitute rules |

Another translation for Table 1 could be a “skip,” which maps the source string to the nul statement in the target language.

An example of a lookup table according to the principles of the invention using three of the mapping rules in Table 1 plus two substitute rules is as follows:

| | |
|---|---|
| Substitute FALSE | false |
| Substitute BOOL | bit |
| D:int pData=var.GetDataPointer(); | hide |
| D:BOOL m_bConected | keep |
| A: *((int *)pData)=(int)nStatus | print |
| A: m_bConnected=FALSE | keep |

In the above example, declarations are prefixed (by the model extractor) with a designation “D:” and assignment are prefixed with a designation “A:” If a match is found, a decision step 21 directs process flow to a process step 23 for applying the interpretation in the table.

In the absence of a user-defined table or in the absence of an entry, the model extractor applies a default type rule, as at 17. For assignments, by way of example, the default rule could be “print.” So, for example, the statement A: *((int *)pData)=(int)nStatus above would need not be explicitly included in the lookup table. In one embodiment, the default interpretations can be overridden by a user, for example, entering new definitions for the default rule in a global, and optional, PREFERENCES file. A decision step 27 determines if a preference applies, and, if so, the default is overridden, as at 19. There can be an entry in this preferences file for each basic type of statement with a corresponding definition that will replace the predefined interpretation. Alternatively, a user can override the default as the model extractor fills the lookup table. When model extraction is repeated, the revised table can be used to generate a model that reflects user preferences. In the illustrative process 10, the table is filled by either the default or the preference, as at 29.

The lookup table can act as an abstraction filter for the source text strings. When applied to the source code, it can determine which operations are relevant to the properties to be verified and which statement can be omitted or represented in simplified form. Irrelevant operations can, for instance, be mapped to the nul operation of the model checker. Source strings that are directly relevant to the property to be verified are generally preserved in the model, with only the minimum requisite syntax adjustments. A string that is entirely outside the scope of the verification is advantageously translated to the nul statement, and is thereby stripped from the model. For a partially relevant string, the lookup table can define a mapping function that preserves only the relevant part and suppresses the rest. Additional information on lookup tables can be found in Holzmann, G. J., and Smith M. H., A Practical Method for the Verification of Event-driven Systems, Proc. Int. Conf. on Software Engineering, ICSE99, Los Angeles, pp. 597-608, May 1999. The example above assumes that the use of variable pData is irrelevant to the property to be proven. The “hide” interpretation suppresses the declaration in the verification model, but the “print” mapped to the assignment preserves visibility of access to the variable. The model extractor will not execute the assignment, but it will print the source text of the statement.

True and false also can be defined as default translations for boolean conditionals from the source program. For each encountered condition in the parse tree, the model extractor always generates both the original condition and its logical negation for explicit representation in the verification model. Both versions are looked up in the lookup table. This permits the extractor to instrument the verification model in such a way that both the truth and falsity of a condition will be considered in the check performed by the model checker (independent of the actual truth value of the condition), or to preserve the truth value of the condition as defined, or to force the evaluation of the condition firmly to either true or false. By assigning true and false respectively to a condition and the negation of a condition, or false and true (or even true and true for the broadest type of check), the abstracted model can be forced to assume either the truth or the untruth of the condition. The lookup table can contain other generic rules that can be applied to each source string or to its target, to obtain a more general type of control over abstractions.

In the following example, the precise determination of whether a given device is idle or busy is considered beyond the scope of the verification:

C: (device_busy(x->line)) true

C: !(device_busy(x->line)) true

The redundancy maps both “idle” and “busy” to true, thus introducing non-determinism into the model. For verification purposes, it suffices that both cases can occur, and the results of the verification should hold regardless of the outcome. Of course, other constraints can be mapped, such as constraining the model to just one case. The verification would then check the operation of the system when the case always holds.

In some cases, the predefined interpretations, such as those in Table 1, may not be adequate to cover the specifics of a particular verification. For example, within a programming language a SEND statement can take various forms, because there is no generally accepted standard library for such operations. In such cases, the statement can be preserved in the model by casting the statement into a specific, standardized format. The table serves to standardize the format for these types of statements, without impeding the freedom of the programmer to choose an arbitrary representation.

Lookup table, preferences file, and defaults for the model extractor may theoretically give different instructions for the conversion of a specific code fragment. Priorities can be assigned to avoid conflicts. In one embodiment, the priorities are: first, the lookup table is searched for an explicit mapping that matches the source string, as at 17. If a match is found, the mapping in the lookup table takes precedence.

If no matching explicit mapping is found, the user preferences file is searched for a data restriction that matches the source string, as at 27. The model extractor first builds a list of data objects that are accessed in the given fragment of source code. For each object, a check is made in the preferences file (if defined) to see if a restriction on that data object was defined. The restriction, if it appears, can be one of the type of entries that appear in Table 1 (e.g., print, keep, etc). If multiple data objects are accessed in a given fragment, each could define a different restriction. In this illustrative case, the priority proceeds from top to bottom in Table 1 (print has highest priority), although it should be apparent that other priorities can be defined depending upon the verification problem at issue. If the source fragment is classified as a condition, a mapping to hide or to comment can be replaced with a mapping to true.

If no explicit mapping is found and no matching data restriction is found, a default type rule is selected based on the class of the source string: assignment, condition, declaration, or function call, as at 17. For each of these statement types, the model extractor applies the default mapping to, for example, the entries of Table 1. The mapping can be optionally overridden by the user using the preferences file, as at 19, or on the fly using an interactive interface (not shown).

Optionally, the lookup table can be shortened by the use of patterns to assign the same mapping to larger groups of entries that match the pattern. For example, if all call of the C-library-functions memcpy are to be hidden, a listing of all different calls can be avoided by using pattern matching. The entry “F: memcpy( . . . ” matches all memcpy function calls. The Substitute rule explained above can also be used, where these rules take effect only on mappings of the keep type, and they are applied in the order in which they are defined in the lookup table. Another illustration of a method for shortening the table is to eliminate any entry that maintains its default mapping. In the illustrative embodiments explained herein, these entries need not appear explicitly in the lookup table.

The translations or interpretations for the source strings are used to generate the verification model in the language of the model checker. A control flow is generated from the source code for each procedure of the source code, as at 24, for example, using the parse tree. The control flow is populated with the interpretations, as at 26. The populated control flow provides the extracted model in the language of the model checker, as at 34.

(3) Optimization

In most, if not all, verifications, significant portions of the source text will have no direct relevance to the verifications of general functional properties of the code. With the corresponding actions hidden, the control structure can be simplified. For example, the following fragment (in SPIN's specification language) specifies a non-deterministic choice between two portions of code mapped to “comment”:

if

:: true→ /* comment1 */

:: true→ /* comment2 */

fi

The model can be simplified without changing its semantics by removing the fragment completely. Similarly,

if

:: true→ stmnt1

fi;

stmnt2

can be reduced to “stmnt1; stmnt2.” For another example, in a structure like “false→ stmnt1; stmnt2; . . . ” everything after the unsatisfiable condition can be omitted. A set of rewrite rules can be used to optimize the model when these cases are present.

(B) Properties

The input into the model checker also includes the properties that the model will be verified against. The particular way in which correctness properties are defined, stored, and used by the model checker for the verification model that is generated by the method disclosed here is outside the scope of this invention. Standard methods to do so include the use the well-known logics known as linear temporal logic (LTL). An positive statement of a correctness requirement expressed as an LTL formula can be negated to formalize all possible violations of the requirement in a systems execution. The negated formula can be translated mechanically into an automaton, which can then used in the model checking process in a standard manner.

(C) Model Checker

Logical model checking can performed using the SPIN model checker. SPIN verification models can define the behavior of systems of asynchronous processes that interact by synchronous or asynchronous message passing, or by shared access to global data. SPIN converts the input specification into a product of automata. The global behavior defined by this product can be checked efficiently for a wide range of correctness properties using an automata theoretic model checking procedure. More information on the automate-theoretic approach to formal verification can be found in: Gerard J. Holzmann, ‘The model checker Spin’, IEEE Trans. On Software Engineering, Vol. 23, No. 5, May 1997, pp. 279-295, and in: Vardi and Wolper, An Automata-theoretic Approach to Automatic Program Verification, Proc. Symp. on Logic in Computer Science, pp. 322-331, Cambridge, June 1986.

SPIN searches the intersection product of the language defined by the system of concurrent processes and the language implicitly defined by the requirement to be proven. The model checking procedure is defined in such a way that if the language intersection product can be proven to be empty, no violation of the requirement is possible. If the intersection product, however, is not empty, it directly defines at least one system execution that demonstrates a potential violation of the requirement by the system. In this case SPIN will generate the execution sequence as proof that the requirement can be violated. As explained, this execution sequence can be reproduced as an execution trace in the original source code of the application by the way in which the model is annotated by the model extractor.

The verification method according to the principles of the invention can be used for systems that interact with outside entities in its environment. These entities can be concurrently executing application processes, remote servers, human users, and the like. For entities that interact with the system, an abstract model that captures the essence of the behavior of the outside entity can advantageously be included in the verification model. This stylized set of assumptions about the behavior of the environment in which the application is to be used are often referred to as test scaffolding or the construction of a test harness. Because the objective is to verify the behavior of a specific system—rather than the behavior of the remote entities—it is sufficient to model remote entities with a conservative estimate of their possible behaviors; i.e., it is desirable to verify behavior of the system despite the presence of possibly ill-behaved remote entities. Therefore, it is sufficient to model remote entities as generic test-drivers with non-deterministic behavior; i.e., the remote entities select from possible behavior non-deterministically. The non-deterministic selections can be generated with simple software demons. Abstractions based upon non-determinism remove complexity by removing extraneous detail and broaden the scope of the verification by representing one of the classes of possible behavior, instead of selected instances of specific behavior.

(D) Exemplary Systems

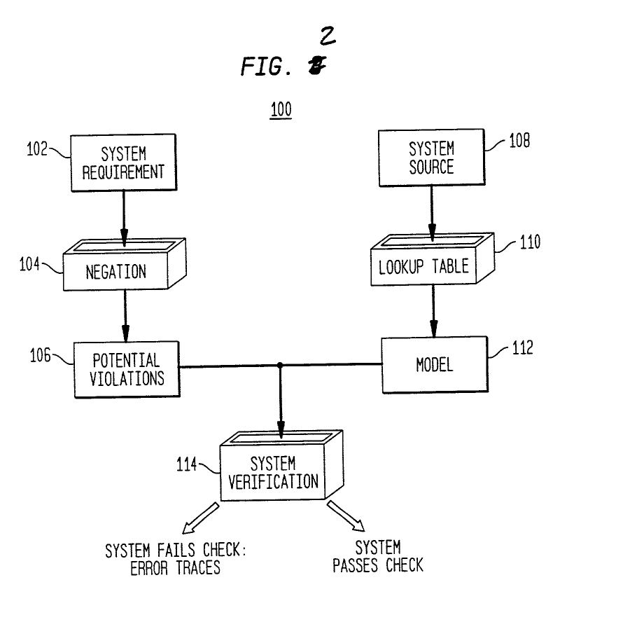

A block diagram for an exemplary system 100 is shown in FIG. 2. The system verification engine 114 implements model checking using, for example, the SPIN model checker described above. The system source code 108 is an input to the abstraction filter (i.e., lookup table) 110, which produces the verification model 112 according to the principles of the invention. The processes described with reference to FIG. 1 are exemplary processes for providing the verification model 112. The system requirements or properties are another input to the system, and can be described independently by conventional means as described earlier. The negation of the system requirement is taken 104 to provide a formalization of all violating executions that can potentially exist 106. These potential violations 106 are checked against the model 112 in the verification engine 114.

The embodiments detailed herein are illustrative and not exhaustive. That is, the aspects of the invention can be applied to any source programming language and extract a verification model in the specification language of any suitable model checking system. In context of software verification systems the aspects of the invention are universally applied to any given source language, e.g. C, C++ or Java, and any given target language, e.g., the Spin model checker.

What is claimed is:

1. A method for extracting a verification model from source code comprising the steps of:
defining a control flow for procedures in the source code;
generating source strings for selected elements of the source code;
associating the source strings to an interpretation according to a plurality of prioritized mapping rules;
applying the associated interpretation to the source strings to translate the source strings to strings of a target language;
generating the verification model in the target language, the generating step including the step of populating the control flow with the strings of the target language, wherein the verification model conforms to the control flow; and
optimizing the verification model according to a property to be verified.

2. The method of claim 1 wherein the plurality of mapping rules comprises at least one explicit mapping.

3. The method of claim 1 wherein the plurality of mapping rules comprises at least one data restriction.

4. The method of claim 1 wherein the plurality of mapping rules comprises at least one default type rule.

5. The method of claim 2 wherein the plurality of mapping rules comprises at least one explicit mapping, at least one data restriction and at least one default type rule.

6. The method of claim 2, wherein associating the source strings to an interpretation according to a plurality of prioritized mapping rules comprises the further steps of:
for each source string:
(a) searching a lookup table for an explicit mapping that matches the source string;
(b) if a matching explicit mapping is found in step (a), associating the source string to the interpretation corresponding to the explicit mapping;
(c) if no matching explicit mapping is found in step (a), determining if a data restriction applies to the source string;
(d) if a single applicable data restriction is determined in step (c), associating the source string to the interpretation corresponding to the single applicable data restriction;
(e) if a plurality of applicable data restrictions are determined in step (c), selecting one of the applicable data restrictions and associating the source string to the interpretation corresponding to the selected data restriction;
(f) if no applicable data restriction is found in step (c), associating the source string to the interpretation according to a default type rule.

7. The method of claim 6 wherein the lookup table contains source string patterns representing a plurality of entries in the lookup table, wherein searching the lookup table includes searching for the source string patterns.

8. The method of claim 1 wherein the application of the mapping rules causes the translating of the source strings to respective equivalent statements in the target language when the selected source code elements are fully relevant to a property to be tested and the translating of the source strings to nul statements in the target language when the selected source code elements are irrelevant to the property to be tested.

9. The method of claim 1, wherein the source code is selected from the group comprising C, C++, and Java.

10. In a computer-based model checker, a method for automatically verifying a property of a system using the system source code, the model checker operable to check a verification model for the property, comprising the steps of:
inputting the source code, a conversion table, a representation of the property and an optional preferences file to the apparatus, the conversion table including strings corresponding to strings of the source code and interpretations mapped to the strings, the preferences file including interpretations for overriding default rule interpretations;
programming the model checker with default rule interpretations, wherein the default rule interpretations when applied by the model checker translate source code strings to a language of the model checker;
defining a control flow for each procedure in the source code;
selecting source code strings for translation from the source code to the language of the model checker;
for each selected string:
according to a predetermined priority, searching the conversion table for entries corresponding to the selected string;
translating the selected string according to the interpretation mapped to the selected string;
applying the default rule interpretation corresponding to the selected string; and
overriding the default rule interpretation according to an entry in the preferences file;
populating the control flow with the interpretations to provide the verification model; and
checking the verification model for the property.

11. A computer based model checker comprising:
a processor for executing instructions;
storage accessible to the processor for storing the instructions, a lookup table, default rules, source code of a system, a property to be verified and an optional preferences file,
the instructions causing the processor to:
parse the source code and to define a control flow for procedures in the source code;
generate source strings for selected source code elements;
selectively associate the source strings to an interpretation according to a plurality of mapping rules, including mapping rules defined in the lookup table, in the default rules and in the optional preferences file;
apply the associated interpretation to the source strings to translate the source strings to strings which can be operated on by the model checker;
populate the control flow with the strings, the populated control flow being a verification model; and
check the verification model for the property; and
an output device responsive to the processor for providing a result of the check.

12. The computer based model checker of claim 11 wherein the model checker is a SPIN model checker.

13. The computer based model checker of claim 11 wherein the interpretations comprise print, hide, comment and keep, wherein print embeds the source string into a print action of the model checker, hide excludes the source string from representation in the verification model, comment includes the source string in the verification model as a comment, and keep preserves the source string in the verification model.

14. The computer based model checker of claim 13 wherein the keep preserves the source string in the verification model subject to global substitute rules.

15. The computer based model checker of claim 11 wherein the lookup table includes entries corresponding to branch conditions.

16. The computer based model checker of claim 15 wherein the entries corresponding to branch conditions include entries for introducing a nondeterministic choice to the verification model.
